(19) United States
(12) Patent Application Publication
(10) Pub. No.: US 2008/0165277 A1
(43) Pub. Date: Jul. 10, 2008

(54) Systems and Methods for Deinterlacing Video Data

(76) Inventors: Natalya Y. Loubachevskaia, Irvine, CA (US); Mohammad Usman, Mission Viejo, CA (US)

Correspondence Address: PATENTMETRIX, 14252 CULVER DR. BOX 914, IRVINE, CA, 92604, US

(21) Appl. No.: 11/971,871

(22) Filed: Jan. 9, 2008

Related U.S. Application Data
(60) Provisional application No. 60/884,361, filed on Jan. 10, 2007.

(51) Int. Cl. H04N 7/01

(52) U.S. Cl. 348/448; 348/E07.003

(57) ABSTRACT

The present invention is directed to systems and methods for deinterlacing a video frame by obtaining a video frame, identifying an edge within the frame, selecting a first pixel within the edge, computing a plurality of non-negative threshold values by applying at least one function to a plurality of pixels proximate to the first pixel, obtaining a plurality of second pixel values based upon the computation of non-negative threshold values, and applying a filter function to the selected plurality of second pixel values.

### CROSS-REFERENCE

The present application relies upon, for priority, U.S. Provisional Application No. 60/884,361 filed on Jan. 10, 2007.

### FIELD OF THE INVENTION

The present invention relates generally to the processing of video images and, more specifically, to a deinterlacing method and system implemented in a processor.

### BACKGROUND OF THE INVENTION

In certain applications, such as DVD content, video images are interlaced. With interlaced video, each half frame is captured, by a camera, at a different moment in time. Pixels in either the odd or even lines are presented at different times.

However, it is often desired to present video content in the form of progressive scan images, rather than interlaced images. In progressive scanning, the horizontal scan lines are scanned on to the screen at one time. Therefore, in progressive scans, the image is displayed on a screen by scanning each line (or row of pixels) in a sequential order, e.g. in numerical order (1,2,3) down the screen from top to bottom, rather than an alternate order, e.g. lines or rows 1,3,5 followed by lines or rows 2,4,6, as is done with interlaced scan. Progressively scanning can yield a smoother, more detailed image, which is often better suited for viewing fine details, such as text. Progressive Scan has long been used in computer monitors. The Digital TV and HDTV standards accept both interlaced scan and progressive scan.

An interlaced video image can be converted to a progressive scan image. Referred to as “deinterlacing”, “line doubling”, or “I to P conversion”, it is a method of combining the odd and even fields of a video to make a progressive-scan video. Using various algorithms that accept, as an input, pixel data from lines above and below the missing lines, new pixel data for the missing lines can be calculated.

More specifically, referring to FIG. 1, deinterlacing of a video frame is depicted. Referring to FIG. 1, an interlaced video frame 102 comprises of two fields, Field 0 105 and Field 1 110 that are temporally placed apart by a time period ΔT 120. Field 0 105 comprises odd scan lines 125 while Field 1 110 comprises even scan lines 130. The two fields 105, 110 are combined to create a progressive video frame 103 that comprises both odd and even lines 140 and has double the vertical resolution of each field. For example, if the fields 105, 110 each have a resolution of 720 horizontal pixels by 240 vertical pixels, then the combined frame 115 has a resolution of 720 horizontal pixels by 480 vertical pixels. Thus, the combined frame 115 of progressive video 103 will have the full vertical resolution available from the source.

With conventional approaches to deinterlacing, wherein both even and odd frames 125, 130 are combined to convert a motion picture formatted for an interlace display into a progressive format, a noticeable “artifact” or error arises because the image content of vertically adjacent lines is time shifted by a period ΔT 120. Naturally, once time shifted, the image data of Field 1 and Field 0 do not precisely match. The error is most visible around the edges of objects that are in motion.

Therefore, what is need is a system and method, implemented on a processor, for deinterlacing a video image, thereby transforming an interlaced image into a progressive scan image, in a manner that minimizes artifacts and errors while still being resource and computationally efficient. What is also needed is a deinterlacing system and method that corrects motion artifacts around sharp edges positioned at various angles in the frame. In particular, what is needed is a deinterlacing system and method that processes edge angles having a N pixel step height and outputs corresponding edge angles having a maximum N+3 pixel step height and, more specifically, a deinterlacing system and method that, for angles in the ranges of 90 degrees to 20 degrees and −90 degrees to −20 degrees, processes edge angles having a N pixel step height and outputs corresponding edge angles having a maximum N pixel step height and, for angles in the range of 20 degrees to 1-3 degrees and −1-−3 degrees to −20 degrees, processes edge angles having a N pixel step height and outputs corresponding edge angles having a maximum N+1 pixel step height.

### SUMMARY OF THE INVENTION

In one embodiment, the present invention is directed to a method for deinterlacing a video frame comprising the steps of obtaining a video frame, identifying an edge within said frame, selecting a first pixel within said edge, computing a plurality of non-negative threshold values by applying at least one function to a plurality of pixels proximate to said first pixel, selecting a plurality of second pixel values based upon said computation of non-negative threshold values, and applying a filter function to said selected plurality of second pixel values.

Optionally, the plurality of non-negative threshold values is equal to four. The step of computing four non-negative threshold values is performed by first identifying a pixel window around said first pixel where the first pixel window is equal to 5 pixels by 3 pixels.

Optionally, the step of computing four non-negative threshold values is performed by, within the pixel window, selecting five pixels from a line before the first pixel, selecting five pixels from a line after the first pixel, and applying a plurality of functions to the five pixels from the line before the first pixel and five pixels from the line after the first pixel. At least one of the plurality of functions is PQ(1)=abs(a−f)+abs(aa−e)+abs(b−ff) wherein aa, a, and b represent the value of three of the five pixels from the line before the first pixel and e, f and ff represent the value of three of the five pixels from the line after the first pixel. At least one of the plurality of functions is PQ(2)=abs(b−f)+abs(a−e)+abs(b−e) wherein a and b represent the value of two of the five pixels from the line before the first pixel and e and f represent the value of two of the five pixels from the line after the first pixel. At least one of the plurality of functions is PQ(3)=abs(c−e)+abs(b−d)+abs(b−e) wherein b and c represent the value of two of the five pixels from the line before the first pixel and d and e represent the value of two of the five pixels from the line after the first pixel. At least one of the plurality of functions is PQ(4)=abs(c−d)+abs(cc−e)+abs(b−dd) wherein b, c and cc represent the value of three of the five pixels from the line before the first pixel and dd, d, and e represent the value of three of the five pixels from the line after the first pixel.

In one embodiment, the non-negative thresholds are sorted, in at least one of ascending order or descending order, and indices of the two smallest threshold values are selected from the sorted non-negative thresholds. Preferably, the filter function is a median filter function applied to the two smallest threshold values to generate an output value, and the value of an output pixel is equal to the output value of the median filter function.

In another embodiment, the present invention comprises a method for deinterlacing a video frame comprising the steps of obtaining a video frame, identifying an input edge having an angle and a step height within the frame, and applying a plurality of functions to pixels within the input edge to generate an output edge wherein, for the input edge having an angle in the range of 90 degrees to 20 degrees and −90 degrees to −20 degrees and a step height equal to N, the corresponding output edge has a step height equal to N and wherein, for the input edge having an angle in the range of 20 degrees to about 1 degree and about −1 to −20 degrees and a step height equal to N, the corresponding output edge has a step height equal to N+1. Additionally, the output edge has a zero motion artifact width.

The methods of the present invention are performed by a processor that processes instructions embodying the method steps disclosed herein, which are stored in a memory accessible to the processor.

### BRIEF DESCRIPTION OF THE DRAWINGS

These and other features and advantages of the present invention will be appreciated as they become better understood by reference to the following Detailed Description when considered in connection with the accompanying drawings, wherein:

FIG. 1 illustrates the basic concept of deinterlacing as employed with the present invention;

FIG. 2 is a flow chart describing the computational core of the deinterlacing method of the present invention;

FIG. 3 illustrates the concept of computing non-negative threshold values for a given pixel;

FIG. 4 illustrates one method of sorting of the array of computed thresholds for a given pixel; and

FIG. 5 is a chart demonstrating the results of the deinterlacing method of the present invention as applied to a sharp edge having a one-pixel step height.

### DETAILED DESCRIPTION OF THE INVENTION

The present invention is a system and method, implemented on a processor, for deinterlacing a video image, thereby transforming an interlaced image into a progressive scan image. The present invention will presently be described with reference to the aforementioned drawings. Headers will be used for purposes of clarity and are not meant to limit or otherwise restrict the disclosures made herein. Where arrows are utilized in the drawings, it would be appreciated by one of ordinary skill in the art that the arrows represent the interconnection of elements and/or components via buses or any other type of communication channel.

The present invention can be implemented in any general purpose or special purpose processor. An exemplary processing system includes a chip architecture having scalable, distributed processing and memory capabilities through a plurality of processing layers, as disclosed in PCT/US06/00622 and pending U.S. patent application Ser. No. 11/813,519, which is incorporated herein by reference. Other exemplary processors are disclosed in U.S. Pat. Nos. 6,226,735, 6,122,719, 6,108,760, 5,956,518, and 5,915,123, all of which are incorporated herein by reference. Exemplary processors further include hybrid digital signal processors (DSPs)/RISC chips that have adaptive instruction sets and instruction set architectures that can be dynamically customized to match the particular requirements of the running applications.

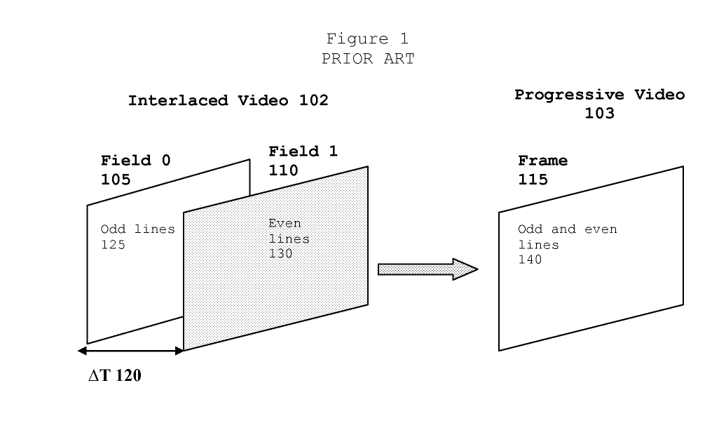

In one exemplary embodiment, processing units within a processor are programmed to implement a method for deinterlacing video that provides efficient conversion of previously interlaced video sequence into progressive video sequence that can be used in any color space and for any pixel precision. As previously discussed, referring to FIG. 1, an interlaced video frame 102 comprises two fields, Field 0 105 and Field 1 110 that are temporally placed apart by a time period ΔT 120. Field 0 105 comprises odd scan lines 125 while Field 1 110 comprises even scan lines 130. The two fields 105, 110 are combined to create a progressive video frame 103 that comprises both odd and even lines 140 and has double the vertical resolution of each field. For example, if the fields 105, 110 each have a resolution of 720 horizontal pixels by 240 vertical pixels, then the combined frame 115 has a resolution of 720 horizontal pixels by 480 vertical pixels. Thus, the combined frame 115 of progressive video 103 will have the full vertical resolution available from the source.

With this conventional approach to deinterlacing, wherein both even and odd frames 125, 130 are combined to convert a motion picture formatted for an interlace display into a progressive format, a noticeable “artifact” or error arises because the image content of vertically adjacent lines is time shifted by a period ΔT 120. The error is most visible around the edges of objects that are in motion.

In order to avoid motion artifacts that result when both even 125 and odd 130 frames are combined, the deinterlacing method of the present invention transforms only one set of lines from a frame, e.g. even or odd, and interpolates the other set of lines of the frame, e.g. even or odd depending on what set of lines were transformed. Further, in order to compensate for any loss of vertical resolution arising as a result of only one set of lines being transformed, the deinterlacing method of the present invention carries out interpolation based on directional median filtering, and can be used for any pixel precision. This novel approach to deinterlacing results in a method and system that can convert any previously interlaced video into a progressive video sequence used in PCs and high definition TV, is color-plane separable and therefore useable in any color space, can be done using only two fields of one frame, and can be used for any pixel precision. For purposes of clarity, one embodiment of the invention shall be described using even lines as the transformed lines and odd lines as the interpolated lines. However, it should be appreciated that the same description can be applied using odd lines as the transformed lines and even lines as the interpolated lines.

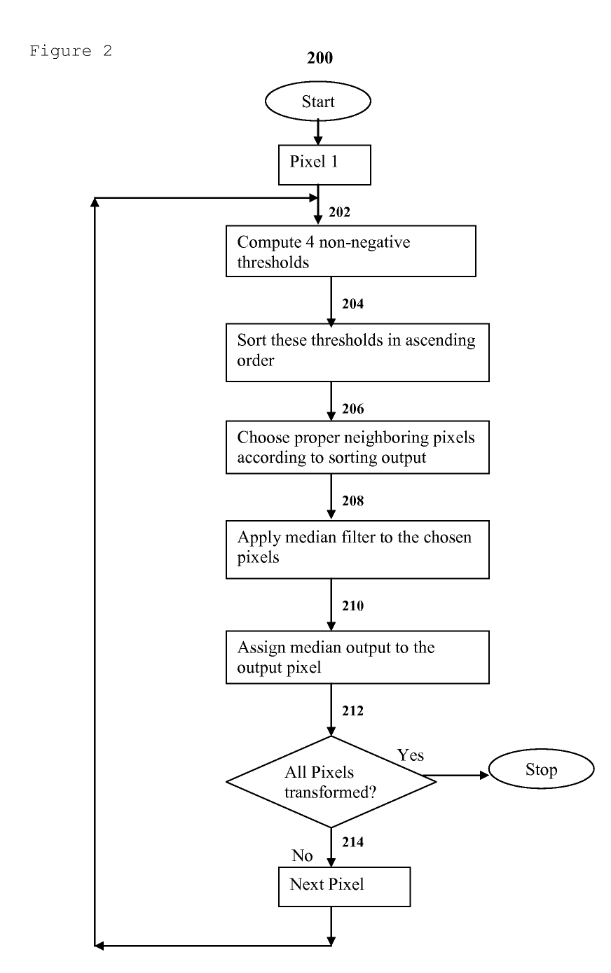

FIG. 2 describes the computational core of the deinterlacing method of the present invention by means of a flow chart. One of ordinary skill in the art would appreciate that the depicted steps here, and in other process steps discussed below, are implemented in a processor using an appropriately designed set of instructions stored in a memory connected to, in data communication with, and/or accessible to the processor.

The steps in the flow chart 200 represent the core transformation that is applied to each pixel/plane of Field 1 110, that is, to all even lines of a frame. Referring to FIG. 2, the first step 202 of the transformation process for a given pixel in an even line involves computing four non-negative thresholds for that pixel. The process of computation of the four non-negative thresholds is explained below. The computation of the four non-negative thresholds enables the more effective determination and/or classification of the type of edge (vertical/close to vertical, e.g. 0 to 30 degrees, diagonal/close to diagonal, e.g. 30-45 degrees or 30-60 degrees, or horizontal/close to horizontal, e.g. 45 to 90 degrees or 60 to 90 degrees) being processed. This classification results in better restoration of diagonal and close-to-horizontal edges, thereby producing noticeable quality improvement along horizontal directions. Prior art approaches fail to effectively classify the type of edge being processed and do not effectively select a subset of pixels targeted to the particular type of edge being processed.

After computing the threshold values, they are sorted 204 in ascending order to obtain the indices of two smallest threshold values. The indices represent the neighboring pixels of the original pixel being transformed, and are taken into consideration for computations in the transformation process. The selection of neighboring pixels based on the output of sorted threshold values is depicted in step 206. Thereafter, a median filter function is applied to the selected neighboring pixels 208, and the output of the median filter function represents the value of the transformed output pixel, as shown in step 210.

The above steps of transformation process are repeated until all the pixels in all the even lines of Field 1 have been transformed. This is depicted through steps 212 and 214. Further details of the individual steps in the transformation process are described as follows.

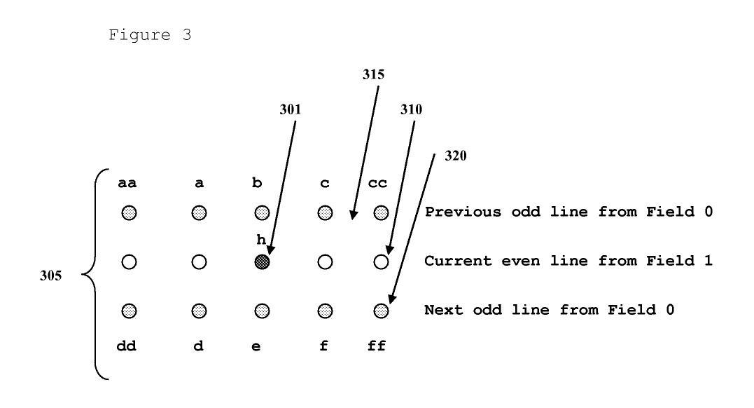

FIG. 3 illustrates how the four non-negative thresholds for each pixel are computed. For computational purposes, a 5×3 pixel window 305 around each pixel to be transformed 301 is considered. In case a pixel is located at the boundary row or column of the field, the transformation method of the present invention assumes line and column repetitions for boundary conditions, that is, the boundary line or column is repeated, beyond the boundary, to fill out the pixel window.

Thus, referring to FIG. 3, a set of pixels 305 is shown, wherein ‘h’ 301 represents the current pixel of the current even line of Field 1 310, which is to be transformed by using the deinterlacing method of the present invention. Five pixels from the previous odd line 315, marked as aa, a, b, c, and cc, and five pixels from the next odd line 320, marked as dd, d, e, f and ff, are considered for computing the four non-negative thresholds for pixel h 301. This computation is based on the following set of formulae:

PQ(1)=abs(a−f)+abs(aa−e)+abs(b−ff);

PQ(2)=abs(b−f)+abs(a−e)+abs(b−e);

PQ(3)=abs(c−e)+abs(b−d)+abs(b−e);

PQ(4)=abs(c−d)+abs(cc−e)+abs(b−dd);

Wherein each PQ(i) represents a non-negative threshold for pixel h 301, and the value of varies from 1 to 4.

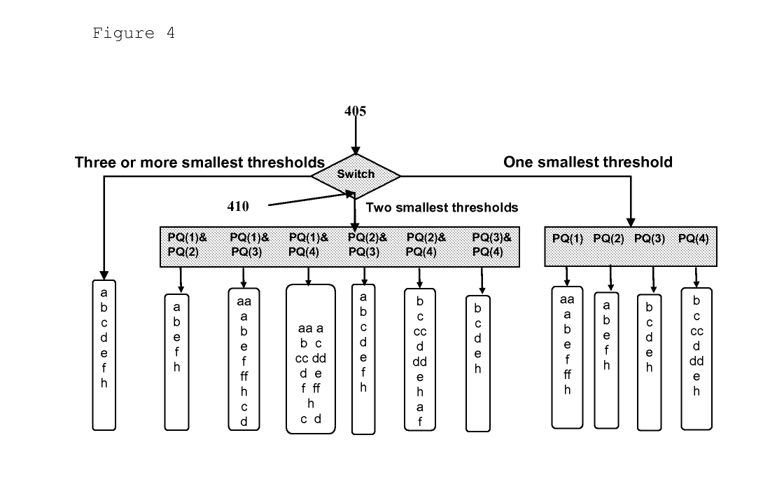

FIG. 4 illustrates one method of sorting of the array of thresholds, whose values were computed in the previous step. In the embodiment shown in FIG. 4, the threshold values are sorted in ascending order, using switch 405, and the indices of two smallest threshold values are selected 410. These indices represent the neighboring pixels of the original pixel that is being transformed. Thus, for example, if as a result of sorting the two smallest thresholds obtained are PQ(2) and PQ(3), then the corresponding array of indices would be:
[a b c d e f h]

Wherein “h” is the pixel being transformed, while the other values represent the neighboring pixels of “h” that are selected for further computation.

One of ordinary skill in the art would appreciate that for the purpose of sorting the array of thresholds may be sorted in ascending or descending order, and any sorting technique such as quick sort, bubble sort, selection sort or any other technique suitable for sorting the array may be applied.

After the array of thresholds is sorted and the indices of two smallest threshold values are obtained to determine the set of neighboring pixels, the next step of the transformation process involves applying a median filter function to the chosen neighboring pixels and assigning the output of the median filter function to the output pixel:

Output pixel=MEDIAN(Neighbors);

Wherein MEDIAN is a function that is applied to an array; and for the purpose of the present step, the array constitutes an array of values of neighboring pixels, as determined in the previous step.

The MEDIAN (Array) function reorders Array values in ascending order and returns
Array element from central position (for an odd number of Array elements); and
Average of two Array elements from a central position (for an even number of Array elements)

The output returned by the median filter function when applied to the array of neighboring pixel represents the value of the pixel h after transformation.

The deinterlacing method of the present invention can use any size pixel window and can use any number of neighbors to calculate a transformed pixel. In one embodiment, the deinterlacing method of the present invention makes use of 5, 7, 9 or 13 neighbors for each transformed pixel. As mentioned previously, the method is color-plane separable, so it can be used in any color space. Further, the method requires no adjustable parameters and therefore offers computational simplicity.

The deinterlacing method and system of the present invention yields high quality processing of video images. Assume an input video frame with a high-contrast object having very sharp edges in movement, such as a white bar rotating clockwise around its center on a black background where the white bar edge is equal to a one pixel width. The deinterlacing method and system of the present invention is applied to this input video frame to yield an output deinterlaced video frame. Ideally, the output deinterlaced edge would have the same sharpness for all edge angles to horizontal direction. Therefore, if the edge is not exactly vertical or horizontal, the edge would comprise a staircase pattern with one-pixel steps (a staircase pattern is unavoidable because of non-zero pixel size of a display).

When the deinterlaced method and system of the present invention is applied to the input video frame having a sharp edge and the maximum height of a step for all edge angles with horizontal direction (an edge that is not exactly vertical) is measured in the output deinterlaced edge, the deinterlaced method and system of the present invention yields an edge having a maximum height of one pixel for all edge angles in the range of 90 degrees to 20 degrees and −90 degrees to −20 degrees (where 90 degrees and −90 degrees represents a fully vertical edge and 0 degrees represents a fully horizontal edge) and yields an edge having a maximum height of two pixels for all edge angles in the range of 20 degrees to close to horizontal (about 1-3 degrees) and close to horizontal (about −1 to −3 degrees) to −20 degrees. In other words, for an edge having a pixel height of N, the present invention yields an output edge having a pixel height of N for all edge angles in the range of 90 degrees to 20 degrees and −90 degrees to −20 degrees and an output edge having a maximum height of N+1 pixels for all edge angles in the range of 20 degrees to close to horizontal (about 1-3 degrees) and close to horizontal (about −1 to −3 degrees) to −20 degrees.

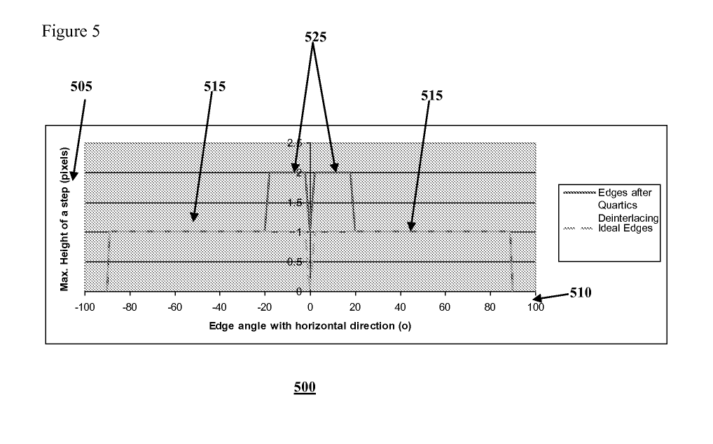

Referring to FIG. 5, table 500 shows the maximum pixel height of each output edge angle, as produced by the methods and systems of the present invention, plotted against the maximum pixel height of a theoretically ideal output edge angle, assuming an input edge angle having a one-pixel step height. Edge angles ranging from 90 degrees to −90 degrees 510 is shown in the x-axis and the maximum pixel height 505 is plotted on the y-axis. Between 90 degrees and 20 degrees and −90 degrees and −20 degrees, the ideal output pixel height and computed output pixel height are equal 515. In other words, for an input edge having a pixel height of N, where the ideal output edge has a pixel height of N, the computed output edge has a pixel height of N. Between 20 degrees and about 1-3 degrees and about −1-−3 degrees to −20 degrees, the ideal output pixel height is 1 and computed output pixel height is 2 525. In other words, for an input edge having a pixel height of N, where the ideal output edge has a pixel height of N, the computed output edge has a maximum pixel height of N+1.

Additionally, the present invention is capable of decreasing the width or length of a motion artifact to near zero. Therefore, when the deinterlacing methods and systems of the present invention are applied to a sharp edge in any orientation, the output edge has a zero motion artifact width. The motion artifact width is the number of additional pixels, relative to the original image, created as an artifact of the motion of the image.

Although described above in connection with particular embodiments of the present invention, it should be understood the descriptions of the embodiments are illustrative of the invention and are not intended to be limiting. Various modifications and applications may occur to those skilled in the art without departing from the true spirit and scope of the invention as defined in the appended claims.

We claim:

1. A method for deinterlacing a video frame comprising the steps of:
a. obtaining a video frame;
b. identifying an edge within said frame;
c. selecting a first pixel within said edge;
d. computing a plurality of non-negative threshold values by applying at least one function to a plurality of pixels proximate to said first pixel;
e. selecting a plurality of second pixel values based upon said computation of non-negative threshold values; and
f. applying a filter function to said selected plurality of second pixel values.

2. The method of claim 1 wherein the plurality of non-negative threshold values is equal to four.

3. The method of claim 2 wherein said step of computing four non-negative threshold values by applying at least one function to a plurality of pixels proximate to said first pixel is performed by first identifying a pixel window around said first pixel.

4. The method of claim 3 wherein said first pixel window is equal to 5 pixels by 3 pixels.

5. The method of claim 4 wherein said step of computing four non-negative threshold values by applying at least one function to a plurality of pixels proximate to said first pixel is performed by, within said pixel window, selecting five pixels from a line before said first pixel, selecting five pixels from a line after said first pixel, and applying a plurality of functions to said five pixels from the line before the first pixel and five pixels from the line after the first pixel.

6. The method of claim 5 wherein at least one of said plurality of functions is PQ(1)=abs (a−f)+abs(aa−e)+abs(b−ff) wherein aa, a, and b represent the value of three of said five pixels from the line before said first pixel and e, f and ff represent the value of three of said five pixels from the line after said first pixel.

7. The method of claim 5 wherein at least one of said plurality of functions is PQ(2)=abs (b−f)+abs(a−e)+abs(b−e) wherein a and b represent the value of two of said five pixels from the line before said first pixel and e and f represent the value of two of said five pixels from the line after said first pixel.

8. The method of claim 5 wherein at least one of said plurality of functions is PQ(3)=abs(c−e)+abs(b−d)+abs(b−e) wherein b and c represent the value of two of said five pixels from the line before said first pixel and d and e represent the value of two of said five pixels from the line after said first pixel.

9. The method of claim 5 wherein at least one of said plurality of functions is PQ(4)=abs(c−d)+abs(cc−e)+abs(b−dd) wherein b, c and cc represent the value of three of said five pixels from the line before said first pixel and dd, d, and e represent the value of three of said five pixels from the line after said first pixel.

10. The method of claim 1 comprising the step of sorting said non-negative thresholds.

11. The method of claim 10 wherein said sorting is in at least one of ascending order or descending order.

12. The method of claim 10 further comprising the step of selecting indices of the two smallest threshold values from the sorted non-negative thresholds as said plurality of second pixel values.

13. The method of claim 12 wherein said filter function is a median filter function applied to said two smallest threshold values to generate an output value.

14. The method of claim 13 further comprising the step of assigning a value to an output pixel wherein said value is equal to the output value of said median filter function.

15. A method for deinterlacing a video frame comprising the steps of:
a. obtaining a video frame;
b. identifying an input edge having an angle and a step height within said frame;
c. applying a plurality of functions to pixels within said input edge to generate an output edge wherein, for said input edge having an angle in the range of 90 degrees to 20 degrees and −90 degrees to −20 degrees and a step height equal to N, the corresponding output edge has a step height equal to N and wherein, for said input edge having an angle in the range of 20 degrees to about 1 degree and about −1 to −20 degrees and a step height equal to N, the corresponding output edge has a step height equal to N+1.

16. The method of claim 15 wherein said output edge has a zero motion artifact width.

17. The method of claim 15 wherein step of applying a plurality of functions to pixels within said input edge comprises selecting a first pixel and computing a plurality of non-negative threshold values by applying at least one function to a plurality of pixels proximate to said first pixel.

18. The method of claim 17 wherein the plurality of non-negative threshold values is equal to four.

19. The method of claim 18 wherein said step of computing four non-negative threshold values by applying at least one function to a plurality of pixels proximate to said first pixel is performed by first identifying a pixel window around said first pixel.

20. The method of claim 19 wherein said step of computing four non-negative threshold values by applying at least one function to a plurality of pixels proximate to said first pixel is performed by, within said pixel window, selecting five pixels from a line before said first pixel, selecting five pixels from a line after said first pixel, and applying a plurality of functions to said five pixels from the line before the first pixel and five pixels from the line after the first pixel.

21. The method of claim 20 wherein at least one of said plurality of functions is PQ(1)=abs (a−f)+abs(aa−e)+abs(b−ff) wherein aa, a, and b represent the value of three of said five pixels from the line before said first pixel and e, f and ff represent the value of three of said five pixels from the line after said first pixel.

22. The method of claim 20 wherein at least one of said plurality of functions is PQ(2)=abs (b−f)+abs(a−e)+abs(b−e) wherein a and b represent the value of two of said five pixels from the line before said first pixel and e and f represent the value of two of said five pixels from the line after said first pixel.

23. The method of claim 20 wherein at least one of said plurality of functions is PQ(3)=abs(c−e)+abs(b−d)+abs(b−e) wherein b and c represent the value of two of said five pixels from the line before said first pixel and d and e represent the value of two of said five pixels from the line after said first pixel.

24. The method of claim 20 wherein at least one of said plurality of functions is PQ(4)=abs(c−d)+abs(cc−e)+abs(b−dd) wherein b, c and cc represent the value of three of said five pixels from the line before said first pixel and dd, d, and e represent the value of three of said five pixels from the line after said first pixel.

25. The method of claim 17 further comprising the step of sorting said non-negative thresholds.

26. The method of claim 25 further comprising the step of selecting indices of the two smallest threshold values from the sorted non-negative thresholds.

27. The method of claim 26 wherein said filter function is a median filter function applied to said two smallest threshold values to generate an output value.

28. The method of claim 27 further comprising the step of assigning a value to an output pixel wherein said value is equal to the output value of said median filter function.
